(19) United States
(12) Patent Application Publication
(10) Pub. No.: US 2015/0039244 A1
(43) Pub. Date: Feb. 5, 2015

(54) Failure Rate Estimation From Multiple Failure Mechanisms

(71) Applicants: BQR RELIABILITY ENGINEERING LTD., Rishon-Lezion (IL); Ariel - University Research and Development Company Ltd., Ariel (IL)

(72) Inventor: Joseph Bernstein, Hashmonaim (IL)

(73) Assignees: BQR RELIABILITY ENGINEERING LTD., Rishon-Lezion (IL); Ariel - University Research and Development Company Ltd., Ariel (IL)

(21) Appl. No.: 14/338,358

(22) Filed: Jul. 23, 2014

(30) Foreign Application Priority Data
Jul. 31, 2013 (GB) 1313714.6

(51) Int. Cl. G01M 99/00; G06F 17/18

(52) U.S. Cl. CPC G01M 99/008; G06F 17/18
USPC 702/34

(57) ABSTRACT

A computerized method for estimating reliability of a system at normal operating conditions. The computerized method includes enables of selection of a plurality of failure mechanisms FMⱼ of the system. The failure mechanisms FMⱼ are estimated to cause failures as time events during use of the system. The failure mechanisms FMⱼ are modeled by respective failure rate models. Failure rates are represented as matrix elements λᵢⱼ which include respective adjustable parameters intrinsic to the failure rate models. Multiple test conditions TCᵢare selected to accelerate the failure mechanisms FMⱼ. Batches i of the systems are tested during accelerated failure rate tests at the test conditions TCᵢ respectively.

### CROSS REFERENCE TO RELATED APPLICATIONS

The present application claims priority from patent application GB1313714.6 filed 31 Jul. 2013 in the United Kingdom Intellectual Property Office by the present inventor, the disclosure of which is incorporated herein by reference.

### BACKGROUND

1. Technical Field

The present invention relates to accelerated failure rate testing of devices and/or systems.

2. Description of Related Art

Accelerated life testing includes estimating the failure rate of a device by subjecting a sample of the devices to conditions (e.g stress, strain, temperature etc.) in excess of normal specifications of service parameters for the device. By analyzing the failure times of the sample, engineers estimate the service life, maintenance intervals and may offer a service policy accordingly including warrantee times for the device.

Failure rate is the frequency with which an engineered system or component fails, expressed, for example, in failures per hour. Failure rate is often denoted by the Greek letter λ (lambda). The failure rate of a device usually depends on time, with the rate varying over the life cycle of the device. The mean time between failures (MTBF) is the inverse of the failure rate (λ). Semi-conductor chip and packaged system reliability is measured by a Failure unIT (FIT). The FIT is a rate, defined as the number of expected device failures per billion part hours. A FIT is assigned for each device. For a system which includes multiple devices, an approximation of the expected system reliability is estimated by multiplying the FIT for the device by the number of devices in the system. Hence, a system reliability model may include a prediction of the expected mean time between failures (MTBF) for an entire system from the sum of the FIT rates for every component.

FIT is defined in terms of an acceleration factor, A_{F} as:

$$F I T = \frac{\# failures}{\# tested * hours * {A}_{F}} \cdot {10}^{9}$$

where #failures and #tested are the number of actual failures that occurred as a fraction of the total number of units subjected to an accelerated test. The acceleration factor, A_{F} is supplied by the manufacturer since only the manufacturer is aware of the failure mechanism being accelerated.

A High Temperature Operating Life (HTOL) qualification test is usually performed as the final qualification step of a semiconductor manufacturing process. The test includes stressing a number of parts, usually about 100, for an extended time, usually 1000 hours, at an accelerated or a voltage higher than a specified operating voltage and at an accelerated temperature or ambient temperature higher than a normal operating temperature. The number of failures during the HTOL test is used to extrapolate an estimated FIT of the device.

The accuracy of the HTOL procedure is limited by two issues. One issue may be lack of sufficient statistical data and the second issue may be that zero failures are found and often presented as results for the HTOL qualification procedure because the time of the test is too short or the stress of the test conditions is not sufficient. Manufacturers may even test parts under relatively low stress levels to guarantee zero failures during qualification testing.

Unfortunately, with zero failures sufficient statistical data for accurate failure rate prediction is not acquired. If the qualification test results in zero failures, then an assumption is made (with only 60% confidence!) that no more than half a failure occurred during the accelerated test. The accelerated test would result, based on the example parameters, in a reported FIT=(½)/100 parts /1000 hour*10⁹ /AF=5000/AF, which can be almost any value from less than 1 FIT to more than 500 FIT, depending on the conditions and model used for acceleration.

Examples of failure mechanisms found in semi-conductor devices include time dependent dielectric breakdown (TDDB), negative bias temperature instability (NBTI), electro-migration (EM) and hot carrier injection (HCl).

Thermal and voltage acceleration factors are based on standard acceleration formulas and published acceleration factors.

The failure rate λ_{TDDB} for time-dependent dielectric breakdown (TDDB) for a field effect transistor (FET) semi-conductor device is:

$${λ}_{T D D B} = B exp ( γ {E}_{ox} - \frac{{E}_{a}}{kT} )$$

where B is technology dependent, Eₒₓ is the externally applied field stress (mega volts per centimeter), γ is the field acceleration factor, Eₐ is the thermal activation energy, k is Boltzmann constant and T is temperature (Kelvin).

Another example is the negative bias temperature instability (NBTI) for a FET semi-conductor device. The failure rate (λ_{NBTI}) for NBTI is given below:

$${λ}_{NBTI} = {[ \frac{Δ p}{{A}_{o}} \times exp ( \frac{E}{{kT}_{appl}} ) \times {( {V}_{G} )}^{α} ]}^{\frac{- 1}{n}}$$

Where Aₒ is a pre-factor dependent on the gate oxide process, Eₐₐ is the apparent activation energy, Tₐₚₚₗ is application channel temperature Kelvin, V_{G} application gate voltage, a measured gate voltage exponent, k is Boltzmann constant, n is the measured time exponent and Δpₜ is a failure criterion as a function of trans-conductance (gₘ) and/or drain saturation current (I_{Dsat}.) of the FET for example.

Yet another example is an Eyring model for hot carrier injection HCI for an N-channel transistor device. The failure rate λ_{HCI} for HCI is given below:

$${λ}_{HCI} = {B}^{- 1} \times {( {I}_{sub} )}^{N} \times exp ( \frac{- {E}_{aa}}{kT} )$$

where Eₐₐ is the apparent activation energy, k is Boltzmann constant, T is temperature (kelvin), I_{sub} is peak substrate current during stressing, B⁻¹ is an arbitrary scale factor based on doping profiles or side wall spacing dimensions for example.

The acceleration factor AF of a single failure mechanism, TDDB for example, is a highly non-linear function of temperature and/or voltage and is shown below as the product between the total acceleration factor AF due to temperature and the acceleration factor AFᵥ due to voltage. The total acceleration factor AF of the different stress combinations is the product of acceleration factors of temperature and voltage:

$$AF = \frac{λ ( {T}_{2} , {V}_{2} )}{λ ( {T}_{1} , {V}_{1} )} = {AF}_{T} \cdot {AF}_{V} = exp ( \frac{{E}_{a}}{k} ( \frac{1}{{T}_{1}} - \frac{1}{{T}_{2}} ) ) exp ( {γ}_{1} ( {V}_{2} - {V}_{1} ) )$$

The acceleration factor model as shown in the equation above is widely used as the industry standard for device qualification. However, it only approximates a single dielectric breakdown type of failure mechanism specifically TDDB and does not correctly predict the acceleration of other mechanisms.

Historically, correlation between the degradation of a single failure mechanism and the degradation of circuit performance is used to estimate expected failure rate of the device and the circuit. The accepted approaches for measuring FIT would, in theory, be reasonably correct if only a single dominant failure mechanism participates in the failure of devices. If there are multiple failure mechanism significantly participating in the failure of the devices, then the traditional approach for failure rate testing would in general not lead to accurate failure rate predictions. When more than one failure mechanism leads to failures, then the degradation of the multiple failure mechanisms should be considered, rather than just a single failure mechanism in order to accurately predict device failure rate.

Thus there is a need for and it would be advantageous to have a method for estimating a failure rate such as FIT and/or reliability under operating conditions using accelerating failure rate testing of a device in which multiple failure mechanisms participate in the device failures.

### BRIEF SUMMARY

Various computerized methods are provided for herein for estimating reliability at normal operating conditions of a system. Multiple failure mechanisms FMⱼ are selected for the system. The failure mechanisms FMⱼ are estimated to cause failures as time events during use of the system. The failure mechanisms FMⱼ are modeled by respective failure rate models.

Failure rates are represented as matrix elements λᵢⱼ which include respective adjustable parameters intrinsic to the failure rate models. Multiple test conditions TCᵢ are selected to accelerate the failure mechanisms Fmⱼ. Batches i of the systems are tested during accelerated failure rate tests at the test conditions TCᵢ respectively. Accelerated failure data including failures of the systems and respective times of the failures are tabulated for the systems of each batch i during the accelerated failure rate tests. The failure rates λᵢⱼ are summed over the failure mechanisms FMⱼ to produce total failure rates λᵢ for each batch i of systems. The total failure rates λᵢ are simultaneously fitted to the accelerated failure data to provide values of the adjustable parameters. A reliability metric of the system is determined at the normal operating conditions using the failure rate models with the values of the adjustable parameters. The reliability metric may be determined and performed simultaneously for all the selected failure mechanisms. The reliability metric may be a total acceleration factor, a mean time between failures or a total failure rate. The order of dominance of the failure mechanisms may be determined so that a virtual failure analysis of the system may be provided.

An exponential probability distribution may be used to model reliability for the failure mechanisms. The failure rates λᵢⱼ estimated respectively from the failure rate models are additive to produce respectively a total failure rate λᵢ . The acceleration factors intrinsic to the failure rate models may be additive to produce respectively a total acceleration factor. A probability distribution other than an exponential probability distribution may be used to model reliability respectively for at least one of the failure mechanisms. The failure mechanisms may be interdependent. The failure mechanisms may cause non-random failures as the time events. The system for which the reliability is being estimated at normal operating conditions may be a product, equipment, building construction, vehicle, material, mechanical component, electronic device, data network and/or communications network.

Various transitory and/or non-transitory computer readable media are provided herein encoded with processing instructions for causing a processor to execute one or more of the computerized methods disclosed herein.

The foregoing and/or other aspects will become apparent from the following detailed description when considered in conjunction with the accompanying drawing figures.

### BRIEF DESCRIPTION OF THE DRAWINGS

The invention is herein described, by way of example only, with reference to the accompanying drawings, wherein:

FIG. 1 illustrates a failure model matrix, according to a feature of the present invention

FIG. 2 illustrates a flow diagram of a method, according to features of the present invention

FIG. 3 shows a simplified block diagram of a computer system usable for executing computerized methods according to the features of the present invention.

The foregoing and/or other aspects will become apparent from the following detailed description when considered in conjunction with the accompanying drawing figures.

### DETAILED DESCRIPTION

Reference will now be made in detail to features of the present invention, examples of which are illustrated in the accompanying drawings, wherein like reference numerals refer to like elements throughout. The features are described below to explain the present invention by referring to the figures.

Before explaining features of the invention in detail, it is to be understood that the invention is not limited in its application to the details of design and the arrangement of the components set forth in the following description or illustrated in the drawings. The invention is capable of other features or of being practiced or carried out in various ways. Also, it is to be understood that the phraseology and terminology employed herein is for the purpose of description and should not be regarded as limiting.

By way of introduction, various embodiments of the present invention are directed to a method for estimating failure rate of devices and/or systems in which multiple failure mechanisms cause failures. If multiple failure mechanisms, instead of a single mechanism, are assumed to be time-independent and independent of each other each failure mechanism is accelerated differently depending on the physics that is responsible for each mechanism.

### Multiple Failure Mechanism Modeling

Knowledge of reliability physics of semiconductor devices has advanced enormously. Many failure mechanisms are well understood and production processes are tightly controlled so that electronic components are designed without having a single dominant failure mechanism and perform over a long service life. Standard High Temperature Over-stressed Life (HTOL) tests generally reveal multiple failure mechanisms during testing, which would suggest also that no single failure mechanism would dominate failure rates during service in the field.

To improve accuracy of failure rate estimation, electronic devices should be considered to have several failure mechanisms. Each failure mechanism ‘competes’ with the others to cause an eventual failure. When more than one failure mechanism exists in a system, then the relative acceleration of each failure mechanism may be defined and averaged at the applied condition. Every potential failure mechanism should be identified and its unique acceleration factor should then be calculated for each mechanism at a given temperature and voltage so the FIT rate can be approximated for each mechanism separately.

In probability theory and statistics, the exponential distribution may be used to describe the time between events in a Poisson process, i.e. a process in which events occur continuously and independently at a constant average rate. Under these assumptions, the exponential distribution may be used to represent the measured reliability of semiconductor devices under accelerated testing. Assuming an exponential distribution, the total failure rate FITₜₒₜₐₗ is the sum of the failure rates per mechanism and is described by:

FITₜₒₜₐₗ=FIT₁+FIT₂+. . . +FITᵢ

where each failure mechanism i leads to an expected failure unit, FITᵢ.

### Acceleration Factor

A total acceleration factor AF_{T} may be based on a combination of competing failure mechanisms. The competing failure mechanisms can be understood further by way of example. Suppose there are two identifiable, constant rate competing failure modes and assume an exponential distribution. One failure mode is accelerated only by temperature denoted by λ₁(T). The other failure mode is accelerated by only voltage, and the corresponding failure rate is denoted as λ₂(V).

By performing the acceleration tests for temperature and voltage separately, the failure rates of both failure modes at respective stress conditions may be obtained and the temperature acceleration factor, AF_{T} and voltage acceleration factor AF_{V} of the mechanisms may be calculated. For the first failure mode there are two failure rates λ₁(T) and λ₁(T₂) at two temperatures T₁ and T₂ respectively, and for the second failure mode there are two failure rates λ₂(V) and λ₂(V₂) at two voltages V₁ and V₂ respectively. T₁ and V₁ are the temperature and voltage respectively at normal operating conditions and T₂ and V₂ are the temperature and voltage under stressed conditions.

The temperature acceleration factor AF_{T} is:

$${AF}_{T} = \frac{{λ}_{1} ( {T}_{2} )}{{λ}_{1} ( {T}_{1} )} , . {T}_{1} < {T}_{2}$$

The voltage acceleration factor AFᵥ is:

$${AF}_{V} = \frac{{λ}_{2} ( {V}_{2} )}{{λ}_{2} ( {V}_{1} )} , . {V}_{1} < {V}_{2}$$

These two equations can be simplified based on different assumptions.

When the two failure rates have an equal probability of failure at normal operating conditions, then λ₁(T₁)=λ₂(V₁):

$$AF = \frac{{AF}_{T} + {AF}_{V}}{2}$$

Therefore, unless the temperature and voltage is carefully chosen so that AF_{T} and AF_{V} are very close, within a factor of about 2, then one acceleration factor will overwhelm the failures at the accelerated conditions.

Using a different assumption when λ₁(T₂)=λ₂(V₂) (i.e. equal probability during accelerated test condition) then acceleration factor AF will take the form:

$$AF = \frac{2}{\frac{1}{{AF}_{T}} + \frac{1}{{AF}_{V}}}$$

The acceleration factor applied to at-use conditions will be dominated by the individual factor with the smallest acceleration. In either situation, the accelerated test does not accurately reflect the correct proportion of acceleration factors based on the understood physics of failure mechanisms.

This discussion can be generalized to incorporate situations with more than two failure modes. Suppose a device has n independent failure mechanisms, and λ_{LTFMi} represents the ith failure mode at accelerated condition, λ_{useFMi} represents the i^{th} failure mode at normal condition, then A_{F} can be expressed. If the device is designed that the failure modes have equal frequency of occurrence during the use conditions:

$$AF = \frac{{λ}_{{use}_{FM 1}} \cdot {AF}_{1} + {λ}_{{use}_{FM 2}} \cdot {AF}_{2} + … + {λ}_{{use}_{FM n}} \cdot {AF}_{n}}{{λ}_{{use}_{FM 1}} + {λ}_{{use}_{FM 2}} + … + {λ}_{{use}_{FM n}}} = \frac{{\sum }_{i = 1}^{n} {AF}_{1}}{n}$$

If the device is designed so that the failure modes have equal frequency of occurrence during the test conditions:

$$AF = \frac{{λ}_{{LT}_{FM 1}} + {λ}_{{LT}_{FM 2}} + … + {λ}_{{LT}_{FM n}}}{{λ}_{{LT}_{FM 1}} \cdot {AF}_{1}^{- 1} + {λ}_{{LT}_{FM 2}} + … + {λ}_{{LT}_{FM n}} \cdot {AF}_{n}^{- 1}} = \frac{n}{{\sum }_{i = 1}^{n} \frac{1}{{AF}_{i}}}$$

From these relations, it is clear that only if acceleration factors for each mode are almost equal, i.e. AF₁≈AF₂, the total acceleration factor will be AF=AF₁=AF₂, and certainly not the product of the two (as is currently the model used by industry). If, however, the acceleration of one failure mode is much greater than the second, the standard FIT calculation could be incorrect by many orders of magnitude.

The matrix approach presented here below, to model useful life failure rate (FIT) for components in electronic assemblies, begins by assuming that each component is composed of multiple failure mechanisms based on its operation, rather than simply a sum of sub-components. For example; Electromigration, Hot-Carrier, NBTI and TDDB are each seen as sub-components of the complete chip. The statistical assumption is made that each mechanism has its own acceleration factor related to voltage, temperature, frequency, cycles, etc. Each sub-component is assumed to approximate the relative likelihood of each mechanism as a proportion of the system FIT. Then, each component can be seen as a summation of intrinsic degradation by individual failure mechanisms multiplied by its relative proportion. statistically, each mechanism has its unique probability in time, however we invoke Drenick's theorem to allow the simultaneous solution, which will be more correct in the real world. Thus a matrix of mechanism models is used, each with it's own relative weight for that individual mechanism, assuming the mechanism models are all constant-failure-rate processes. Hence, the standard system reliability FIT can be modeled using traditional MIL-handbook-217 type of algorithms and adapted to known system reliability tools.

The above approach allows accelerated testing to be performed at increased voltages, temperature and power levels to increase the separation of individual mechanisms in order to calibrate the matrix of mechanism models to actual components in a system. The matrix of mechanism models is then solved using input from multiple accelerated tests as compared to the relative contribution of each assumed mechanism. Solving the matrix of mechanism models requires multiple High Temperature Overstress Life-tests (M-HTOL) in order to accelerate different mechanisms in the same set of accelerated tests. The M-HTOL test allows calculations that consider all conditions simultaneously. Thus, an appropriate failure rate calculation will determine the failure rate during actual operating conditions. Furthermore, a system can be de-rated for increased robust design and prolonged failure-free operation, which is accomplished by solving the matrix of mechanism models assuming any desired stress condition using the same proportionality factors as determined by the M-HTOL test.

As part of calibrating the proportionality factors, accelerated test results can be used as input to calculated failure rates for all the failure mechanisms. The output of accelerated life test determines the proportional acceleration factors for each of the various mechanisms. It is assumed the circuit itself is what determines the relative contribution of each mechanism, so a matrix is constructed based on the physics models (JEDEC or manufacturer based) solved for the experimental results. The matrix becomes a forecasting tool that allows determining the dominance of each failure mechanism and its relative contribution to the chance occurrence of a system failure. By solving a system of equations whose information can be obtained from the matrix, one can make an assessment and prediction of acceleration for each combination of failure mechanism and its proportion in the circuit. This model assumes a constant total failure rate so the time at which a given percentage will fail can be used to calculate the duration of the warranty period and the approximate lifetime of the component.

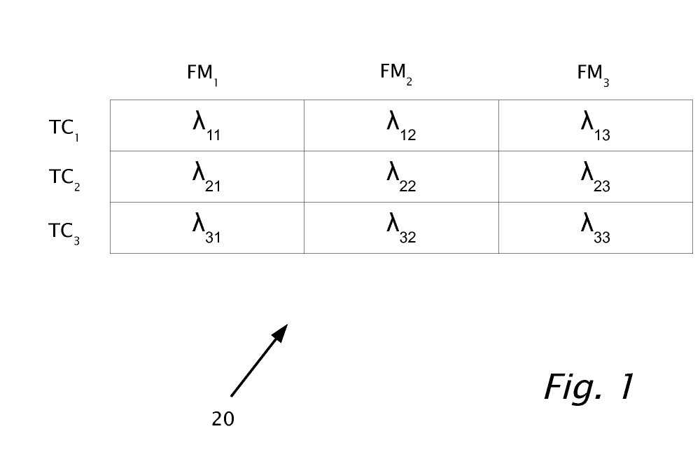

Reference is now made to FIG. 1 which illustrates features of the present invention, a matrix 20 with 3 rows labeled test conditions TCᵢ, for i=1 to 3 and with three columns labeled failure mechanisms FMⱼ and for j=1 to 3. The failure mechanisms FMⱼ and corresponding failure models are selected to be accelerated under the accelerated conditions TC₁, TC₂ and TC3 being used. The test conditions TCᵢ are selected to accelerate failure mechanisms FMⱼ based on the respective failure models being used. The matrix elements of matrix 20 include 9 failure rates λᵢⱼ. For instance, λ₁₂ is the failure rate of the sample tested under test condition TC₁ due to failure mechanism FM₂ and λ₃₂ is the failure rate of the sample tested under test condition TC₃ due to failure mechanism FM₂.

Using an example of three batches of N=100 hundred devices of the same type; TC₁, TC₂ and TC₃ are three test accelerated test conditions applied to the three batches of devices respectively. Using the example of semi-conductor devices, the three test conditions TCᵢ may include various combinations of different applied voltages, currents and frequencies for each of the three batches of semiconductor devices and/or subsystems. Failure mechanisms FM₁, FM₂ FM₃ are three failure mechanism appropriate for the semiconductor device being tested under the test conditions TCᵢ.

Assuming an exponential probability distribution for the failure mechanisms FMⱼ, a total failure rate λᵢ for each test condition TCᵢ may be determined which adds the failure rates of λᵢⱼ for j=1 . . . n failure mechanisms FMⱼ according to the following equation,

$${λ}_{i} = {\sum }_{j = 1}^{n} {w}_{j} {λ}_{ij}$$

where wⱼ is a weighting factor for each failure mechanisms FMⱼ. The weighting factors wⱼ may be considered as including the multiplicative constant factors generally present in models of failure mechanisms FMⱼ and hereinafter the failure rate models of matrix elements λᵢⱼ may be used which have the constant multiplicative factors removed.

For i=1, 2 and 3, there are three total failure rates λ₁, λ₂, λ₃ for the three samples tested under test the three test conditions TC₁, TC₂ and TC₃ respectively, each of the total failure rates λ₁, λ₂, λ₃ including failures summed over the three failure mechanisms FMⱼ:

$${λ}_{1} = {\sum }_{j = 1}^{3} {w}_{j} {λ}_{1 j}$$

$${λ}_{2} = {\sum }_{j = 1}^{3} {w}_{j} {λ}_{2 j}$$

$${λ}_{3} = {\sum }_{j = 1}^{3} {w}_{j} {λ}_{3 j}$$

A reliability function R(t) may be defined is the number of surviving devices as a function of time t, normalized by dividing by the number N of devices in the test sample. Reliability function R(t) varies between 1 just before the time of the first failure to 0 just after all the samples have failed. Assuming device failures are independent and have a constant failure rate λ, an exponential distribution may be assumed, the reliability function R(t) has the form:

R(t)=e^{-λt}

For each of three batches, total failure rates λ₁, λ₂, λ₃, three reliabilities R₁(t), R₂(t) and R₃(t) as a function of time t may be calculated from:

Rᵢ(t)=e^{-λ}^{ᵢ}^{t}

where i=1,2,3 which refers to the batch number. Substituting with the equations above for total failure rates λ₁, λ₂, λ₃ yields the following equations which may be linearized by taking a natural logarithm of both sides.

$$\frac{- ln {R}_{i} ( {t}_{i} )}{{t}_{i}} = {\sum }_{j} {w}_{j} {λ}_{ij}$$

In the equations above, index i is appended to time variable tᵢ to indicate that the time scales and the time data are generally different for the different batches and test conditions i. The right side of the equation above includes failure rate models as matrix elements λᵢⱼ of matrix 20, weighting factor λᵢⱼ which are adjustable parameters along with adjustable parameters intrinsic to failure rate models The sum is over failure rates 2 for the different failure mechanisms FMⱼ.

The left side of the equation is tabulated by the manufacturer or test institute for each batch i and test condition TCᵢ from the actual test results measured. For example, if for batch 1, 50% of the batch survived 1000 hours of testing, then the tabulated measured failure rate datum is −ln(0.5)/(1000 hours) or 6.93·10⁻⁴ hours⁻¹. Data for multiple times tᵢ for each batch i are used to solve for the adjustable parameters including the weighting multiplicative factors wⱼ and the other adjustable parameters intrinsic to failure rate models λᵢⱼ

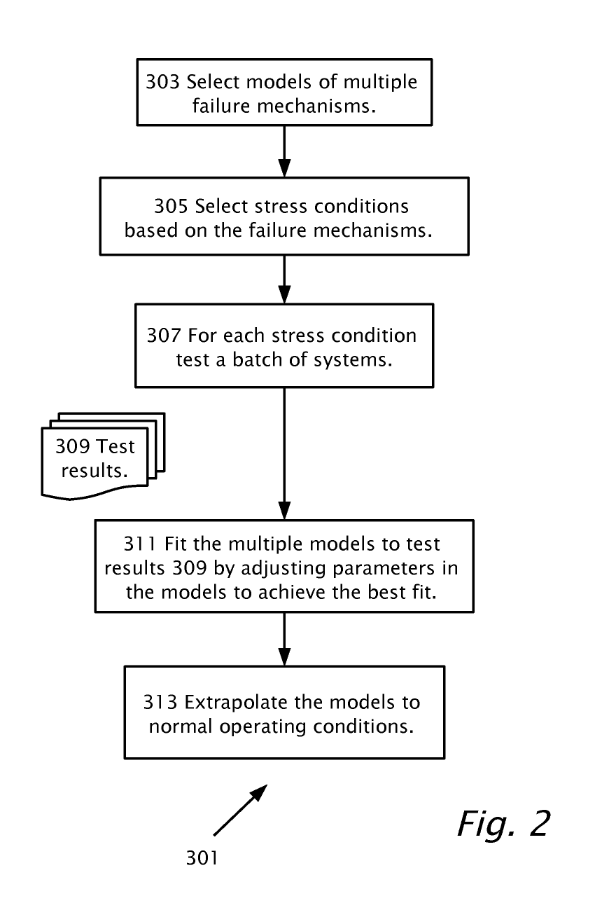

Reference is now also made to FIG. 2 which illustrates a flow chart of a method 301, according features of the present invention. Method 301 is a method to predict reliability of a system which has multiple failure mechanisms FMⱼ. In step 303, the failure mechanisms FMⱼ are selected based on the known physics of reliability of the system. The specific failure mechanisms is normally known by the test institute or manufacturer before the accelerated tests are performed. At least two failure mechanisms FMⱼ are selected which correspond to expected failure mechanisms FMⱼ to cause failures in the systems being tested. In step 305, the accelerated test conditions TCᵢ are selected based on the failure mechanisms selected in step 303 so that the failure mechanisms are suitably accelerated by the test conditions TCᵢ selected. For each accelerated test condition TCᵢ a different batch of systems is tested in step 307. Using the example of a semi-conductor device, the test conditions applied in step 307 may include various combinations of different applied voltages, currents and frequencies for each of the batches of semiconductor devices.

In step 311, test results 309 for each of the batches of systems are then used to fit the failure rate models of the respective failure mechanisms FMⱼ. For instance, weights wⱼ and other intrinsic parameters such as activation energies in the failure rate models λᵢⱼ are adjusted to achieve the measured reliability test results 309.

For each batch of systems, failure rate models λᵢⱼ may be fit (step 311) to the test results 309 by simultaneously solving for the values of adjusted parameters including weights wⱼ. intrinsic activation energies and other intrinsic parameters are derived to complete the failure models λᵢⱼ. The failure rates models may now be used extrapolate (step 313) a reliability metric for normal operation conditions of the system.

A reliability function Rᵤₛₑ(t) under normal use or operation conditions may be calculated using the same failure models λᵢⱼ with the parameters solved for under stress conditions while using values of normal operation conditions, e.g. temperature and voltage.

### Interdependent Failure Mechanisms or Non-Random Failure Events

When failure mechanisms are dependent on each other and/or are not random in time use of of exponential distribution to model reliability may not be strictly appropriate mathematically. Despite mathematical formality, the reliability predictions may still be reasonably accurate while modeling accelerated failure rate using an exponential distribution as shown.

Alternatively, according to other embodiments of the present invention, probability distribution used for different failure mechanisms FMj may be different. For example, for sample batch i, total reliability Rᵢ(t) for three failure mechanisms 1,2,3 may be calculated numerically from:

Rᵢ(t)=R₁(λ₁, t)·R₂(λ₂, t)·R₃(λ₃, t)

R₁,, R₂, and R₃ are different reliability distributions for different failure mechanisms 1,2,3. The reliability distributions R₁, R₂, and R₃ may or may not be exponential. A reliability metric for interdependent failure mechanisms and/or non-random failure events may be accurately determined using the equation above by solving for example with numeric optimization techniques.

### Virtual Failure Analysis

Conventional failure analysis of a mechanical part or semi-conductor device generally requires examination and/or testing of the failed device to determine the detailed mechanism of failure. Use of methods according to the present invention may provide information regarding the failure mechanism of a device without subjecting the failed devices to any test or examination. Using different failure models and sufficient reliability data, the simultaneous solution of the adjustable parameters intrinsic to the failure models based on the reliability data provides a mechanism to determine which failure mechanisms cause device failures and the relative importance or dominance of the different failure mechanisms. As such, embodiments of the present invention provide an additional contribution to the area of reliability physics and engineering.

Although the embodiments presented use a reliability function other functions may be equivalently used depending on the details of the failure rate models and the probability distribution. For instance, an unreliability function may be used equivalently which is defined as the complement of reliability and varies from zero to one as the devices fail during time in an accelerated test.

In sum referring to the description above, a simple and accurate way to combine the physics of failure equations for reliability prediction from accelerated life testing has been presented. Shown is a matrix approach which allows the known reliability physics equations to be fit proportionally to the results of monitored accelerated life testing in order to extrapolate the failure rate one would expect given actual operating parameters. This methodology can be extended to include radiation effects, frequency and even packaging and solder joint effects to give a complete system reliability evaluation framework and a meaningful failure rate (FIT) calculation. This approach further provides factors calculated from experimental results from multiple accelerated life tests of the actual chip and does not rely on simulation. The matrix is solved for any set of operating conditions based on acceleration factor calculations inputted to the matrix which yields true proportional values for the acceleration of each mechanism based on experimental results for the actual chip and can be applied to any user specified operating conditions. Thus, an accurate FIT calculation is provided based on the sum-of-failure-rates from known failure rate model calculations. Thus further, a mechanism is known that will dominate at any user's operational conditions without performing a failure analysis. Also, an overall expected failure rate can be calculated for any specified operating conditions.

The term “system” and “device” are used herein interchangeably and general refer to any product, equipment, building construction, material, mechanical device, network, aeronautic equipment, medical equipment, automotive equipment, transportation equipment and military equipment for which the methods for determining reliability and/or service failure rate may be applicable.

The term “stress” in the context of “stress conditions” refers to any variable of the test conditions for performing accelerated failure rate test on any system or device. The variables selected for stressing the systems and/or devices under test may be voltage, power, current, frequency as examples in electronic systems, stress, strain, force, pressure, frequency for example in mechanical systems.

The term “failure rate model” as used herein refers to a mathematical expression describing failure rate and/or time between failures or equivalent for a single failure mechanism of the system. The term “adjustable parameters” as used herein refers to unknown parameters in the failure rate models which are estimated or derived by the methods of accelerated testing as disclosed herein.

The term “simultaneous fitting” as used herein refers to solving a set of equations together to determine the unknown or adjustable parameters in the failure rate models. Simultaneous fitting may be performed using any analytical technique such as linear algebra or numeric techniques known in the art such as numeric optimization techniques performed in a computer system.

The term “batch” as used herein refers to a sample of like or identical systems or devices used for accelerated failure rate testing according to embodiments of the present invention.

The terms “estimate” and “predict” in the context of estimating reliability and/or failure rate are used herein interchangeably refer to determining a reliability metric of a system or device.

Although various embodiments of estimation of reliability and/or service failure rate have been described in the context of semiconductor electronic components, the present invention in other various embodiments may be applied to any product, equipment, construction, material, mechanical component, device, system, data networks and/or communications networks. Some embodiments may be particularly suitable for aeronautic equipment and military equipment including weapons, medical equipment and transportation vehicles.

Embodiments of the present invention may include a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such non-transitory computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

In this description and in the following claims, a “network” is defined herein as any architecture where two or more computer systems may exchange data. Exchanged data may be in the form of electrical signals that are meaningful to the two or more computer systems. When data is transferred or provided over a network or another communications connection (either hardwired, wireless, or a combination of hardwired or wireless) to a computer system or computer device, the connection is properly viewed as a computer-readable medium. Thus, any such connection is properly termed a transitory computer-readable medium.

Combinations of the above should also be included within the scope of computer-readable media. Computer-executable instructions comprise, for example, instructions and data which cause a general-purpose computer system or special-purpose computer system to perform a certain function or group of functions.

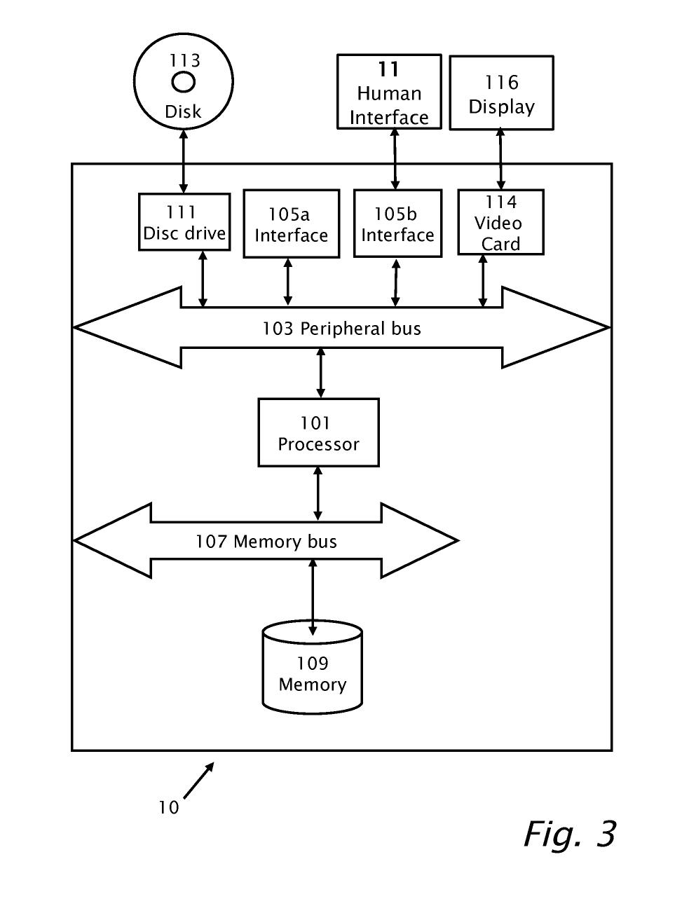

Reference is now made to FIG. 3 which shows a simplified block diagram of a computer system 10, for performing various embodiments of the present invention. Computer system 10 includes a processor 101, a storage mechanism including a memory bus 107 to store information in memory 109 and interfaces 105a and 105b operatively connected to processor 101 with a peripheral bus 103. Human interface 11, e.g. mouse/keyboard are shown connected to interface 105b. Computer system 10 further includes a data input mechanism 111, e.g. disk drive for a computer readable medium 113, e.g. optical disk. Data input mechanism 111 is operatively connected to processor 101 with peripheral bus 103. Operatively connected to peripheral bus 103 is video card 114. The output of video card 114 operatively connected to the input of display 116.

The indefinite articles “a”, “an” as used herein, such as “a failure mechanism”, “a test condition” has the meaning of “one or more” that is“one or more failure mechanisms”, “one or more test conditions”.

Although selected features of the present invention have been shown and described, it is to be understood the present invention is not limited to the described features. Instead, it is to be appreciated that changes may be made to these features without departing from the principles and spirit of the invention, the scope of which is defined by the claims and the equivalents thereof.

What is claimed is:

1. A computerized method for estimating reliability of a system at normal operating conditions, the computerized method comprising:
enabling selecting of a plurality of failure mechanisms FMⱼ of the system, wherein the failure mechanisms FMⱼ are estimated to cause failures as time events during use of the system; wherein the failure mechanisms FMⱼ are modeled by respective failure rate models, wherein failure rates are represented as matrix elements λᵢⱼ which include respective adjustable parameters intrinsic to the failure rate models;
wherein multiple test conditions TCᵢ are selected to accelerate the failure mechanisms FMⱼ, wherein batches i of the systems are tested during accelerated failure rate tests at the test conditions TCᵢ respectively; wherein accelerated failure data including failures of the systems and respective times of the failures are tabulated for the systems of each batch i during the accelerated failure rate tests;
enabling summing the failure rates λᵢⱼ over the failure mechanisms FMⱼ to produce total failure rates λᵢ for each batch i of systems;
enabling simultaneously fitting the total failure rates λᵢ to the accelerated failure data to provide values of the adjustable parameters; and
enabling determining of a reliability metric of the system at the normal operating conditions using the failure rate models with the values of the adjustable parameters.

2. The computerized method of claim 1, wherein said enabling determining of the reliability metric is performed simultaneously for all the selected failure mechanisms.

3. The computerized method of claim 2. wherein the reliability metric is selected from the group consisting of: a total acceleration factor, a mean time between failures and a total failure rate.

4. The computerized method of claim 1, further comprising:
enabling determining the order of dominance of the failure mechanisms, thereby providing a virtual failure analysis of the system.

5. The computerized method of claim 1, wherein an exponential probability distribution is used to model reliability for the failure mechanisms.

6. The computerized method of claim 5, wherein the failure rates λᵢⱼ estimated respectively from the failure rate models are additive to produce respectively a total failure rate λᵢ.

7. The computerized method of claim 5, wherein acceleration factors intrinsic to the failure rate models are additive to produce respectively a total acceleration factor.

8. The computerized method of claim 1, wherein a probability distribution other than an exponential probability distribution is used to model reliability respectively for at least one of the failure mechanisms.

9. The computerized method of claim 8, wherein the failure mechanisms are interdependent.

10. The computerized method of claim 8, wherein the failure mechanisms cause non-random failures as the time events.

11. The computerized method of claim 1, wherein the system for which the reliability is being estimated at normal operating conditions is selected from the group consisting of: a product, equipment, building construction, vehicle, material, mechanical component, electronic device, data network and/or communications network.

12. A computer readable medium encoded with processing instructions for causing a processor to execute the computerized method of claim 1.
